(19) United States
(12) Patent Application Publication
(10) Pub. No.: US 2011/0050757 A1
(43) Pub. Date: Mar. 3, 2011

(54) CONFIGURATION OF CURRENT REGULATORS FOR LED-BASED FLEXIBLE VIDEO SCREENS

(76) Inventor: José Vicente Bosch Esteve, Alcoy (Alicante) (ES)

(21) Appl. No.: 12/812,256

(22) PCT Filed: Jan. 12, 2009
(86) PCT No.: PCT/ES09/00011

§ 371 Date: Jul. 9, 2010

(30) Foreign Application Priority Data
Jan. 11, 2008 (ES) P200800071

(51) Int. Cl. G09G 3/32; G09G 5/10

(52) U.S. Cl. 345/691; 345/212; 345/83

(57) ABSTRACT

The present invention presents a distribution of four pixels (2) on each module (1), having current regulators for the respective groups of LEDs connected in series; so that the regulators are applied to the groups of LEDs in function of the color of the LEDs and in numbers depending on the energetic requirements of the three types of LEDs (R, G and B), allowing independence the consumption of LEDs according to their color.

### OBJECT OF THE INVENTION

The present invention, such as this specification sets forth in its title, relates to a configuration of current regulators for LED-based flexible video screens which main purpose consists of facilitating a certain way for organizing a set of specific analog drivers in order to facilitate the implementation of flexible video screens, and enabling an energetic saving by allowing independence the consumption of LEDs in function of their color.

### BACKGROUND OF THE INVENTION

The flexible video screens based on LED diodes are known, these screens being formed using a regular matrix of LED diodes, constituting the most efficient mechanism for constructing large dimensions screens.

In practice, LED diodes-based video screens are implemented following the same general guidelines. They are physically installed in special boxes so that the LED panels are placed at the front part and all the electronic circuitry necessary for its operation is protected inside of it. This electronic is also usually implemented in the same way: some power supply sources generate one or several low voltage tensions from the power supply network. A circuitry usually constituted by integrated analog drivers controls the luminosity of each one of the LEDs. Finally, a control electronic manages the transmission and generation of images in screen.

The difficulty of implementing flexible video screens lies, firstly, in integrating all the needed electronic, including the own LEDs, in a much reduced profile, typically in a single printed circuit board. The characteristics that this electronic must satisfy are basically those of individually controlling the luminosity of each one of the LEDs. Secondly, the implementation of the analog driver should be as such that it makes that the supply current necessary for its correct operation be sufficiently reduced so as this can be efficiently transported along the entire screen. It should be taken into account that in order to solve this problem is not possible to introduce dc/dc converters in the reduced profiles required by flexible video screens, either is possible to use large section conductors for transporting these currents.

On the other hand, the analog driver which electric scheme is represented in FIG. 1 of this specification, belonging to the state of the art and similar to that described in the U.S. Pat. No. 4,473,891, is known.

In that driver of FIG. 1, the regulator or constant current supply source provides a constant current to all the LEDs of a certain group. Each one of the LEDs turns on or off using the MOS transistors connected in parallel with each one of the diodes. The regulator has a control entry that allows stopping the current when all the LEDs are turned off, thus reducing the consumption.

The number of LEDs that can be connected in series for a driver, as that of FIG. 1, is limited in practice by the maximum gate-to-emitter tension of the transistors. The sum of the direct tensions of all the LEds, in the worst case, should be such as it makes the gate tension of the transistors not to go beyond that maximum value under any circumstance.

We do not know in the current state of the art, the configurations of current regulators for flexible video screens wherein the consumption of LEDs becomes independent according to their color, such as the present invention does.

### DESCRIPTION OF THE INVENTION

In order to achieve the objectives and avoid the drawbacks mentioned in the foregoing paragraphs, the invention consists of a configuration of current regulators for LEDs-based flexible video screens, wherein the video screen has a plurality of pixels and each pixel is composed by a red LED, a green LED and a blue LED; further existing current regulators that provide constant currents to the respective groups of LEDs connected in series; and the pixels being physically distributed in modules with flexible joints between each other, each one of such modules presenting four pixels.

Innovatively, according to the invention, the referred regulators are applied to the corresponding groups of LEDs in function of the color of the LEDs and in numbers depending on the energetic requirements of the three types of LEDs; so that a first number of regulators wherein each regulator is only applied to red LEDs, a second number of regulators wherein each regulator is only applied to green LEDs, and a third number of regulators wherein each regulator is only applied to blue LEDs will exist; thus allowing independence the consumption of LEDs according to their color.

According to a preferred embodiment of the invention, the referred second number is established in an amount triple than that of the referred third number, whereas the eluded first number is established in an amount double than that of the referred third number.

In addition, in this preferred embodiment of the invention, the screen is structured into lineal sets of modules, each lineal set being formed with six modules provided with six respective regulators; so that a first regulator is applied to eight green LEDs of the two modules arranged in the most left side of the lineal set, a third regulator is applied to eight green LEDs of the two central modules of the lineal set, a fifth regulator is applied to eight green LEDs of the two modules arranged in the most right side of the lineal set, a second regulator is applied to twelve red LEDs of the three modules arranged in the most left side of the lineal set, a sixth regulator is applied to twelve red LEDs of the three modules arranged in the most right side of the lineal set, and a fourth regulator is applied to twenty four blue LEDs of the six modules of the lineal set.

On the other hand, in this preferred embodiment, the total turn-on time of these twenty four blue LEDs is divided into three parts, so that in a certain moment of time no more than eight blue LEDs are simultaneously turned on.

According to an alternative of the mentioned preferred embodiment, the referred second number can be established in an amount triple than that of the referred first number, whereas the eluded third number can be established in an amount double than that of the referred first number. In this alternative, the screen is structured into lineal sets of modules, each lineal set being formed with six modules provided with six respective regulators; so that a first regulator is applied to eight green LEDs of the two modules arranged in the most left side of the lineal set, a third regulator is applied to eight green LEDs of the two central modules of such set, a fifth regulator is applied to eight green LEDs of the two modules arranged in the most right side of the lineal set, a second regulator is applied to twelve blue LEDs of the three modules arranged in the most left side of the lineal set, a sixth regulator is applied to twelve blue LEDs of the three modules arranged in the most right side of the lineal set, and a fourth regulator is applied to twenty four red LEDs of the six modules of the lineal set. In addition, in this alternative, the total turn-on time of these twenty four red LEDs is divided into two parts, so that in a certain moment of time no more than twelve red LEDs are simultaneously turned on, whereas the total turn-on time of the referred twelve blue LEDs is divided so that in a certain moment of time no more than eight blue LEDs are simultaneously turned on.

According to the described structure, the invention provides advantages relating to allow independence the consumption of LEDs in function of their color. It further allows a lineal electronic that does not use any inductive component, so that it can be integrated in a reduced profile. With the configuration of current regulators of the present invention it is possible to implement flexible video screens with consumptions similar to those of the conventional rigid video screens. Using the invention, the sum of the direct tensions corresponding to the LEDs of each one of the regulators provides very similar values, which means that a same supply tension can be used for all the regulators without causing significant efficiency losses therein.

Statistically, most part of LEDs for a same color component forming the pixels of an image usually reproduces light intensity values similar to those of its closest neighbor LEDs, so that by taken into account this property a very significant reduction on the consumption is enabled if a configuration as that described in this paragraph is used. With such configuration the consumption in each one of the three color component becomes independent, and the tension drops are efficiently divided, further allowing the integration in a screen of much reduced profile.

Next, in order to facilitate a better understanding of this specification and being an integral part thereof, figures wherein the object of the invention, as well as part of the state of the art, has been represented in an illustrative and non limitative manner are attached.

### BRIEF DESCRIPTION OF THE FIGURES

FIG. 1.—Represents an electric scheme of a driver of the state of the art used in screen based on LEDs.

FIG. 2.—Schematically represents a distribution of modules and pixels used in the configuration of the present invention.

FIG. 3.—Schematically represents a lineal set of six modules, according to the distribution of the previous FIG. 2, the association between the regulators and diodes of the pixels being included, according to a preferred embodiment of the present invention.

FIG. 4.—Schematically represents a lineal set of six modules, in a similar way to the previous FIG. 3, but in an alternative wherein instead of using two regulators for red LEDs and one regulator for blue LEDs, one regulator for red LEDs and two regulators for blue LEDs are used.

### DESCRIPTION OF AN EMBODIMENT EXAMPLE OF THE INVENTION

A description of an embodiment example referring to the numbering adopted in the figures is made bellow.

Thus, the configuration of this example of the invention is applied in video screens that present a plurality of pixels 2, each pixel being composed by a red LED R, a green LED G and a blue LED B.

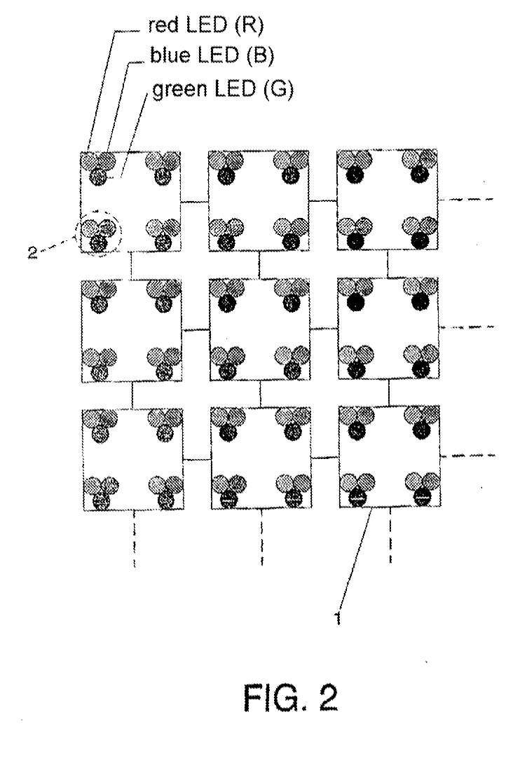

In this application, the flexible video screens consists of a plurality of modules 1 connected between each other, presenting each one of these modules four pixels 2, as can be appreciated from FIG. 2. Each one of these modules is physically connected with the remaining parts through flexible joints.

There are twelve LEDs in total in each one of the modules 1.

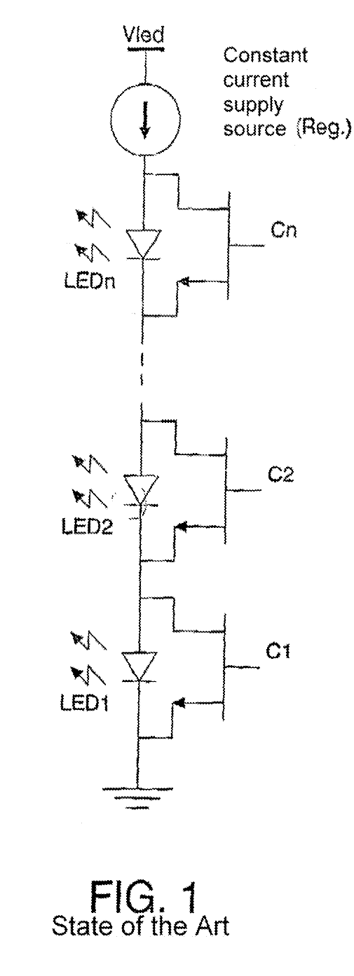

In addition, the screen will have current regulators REG providing constant currents to the respective groups of LEDs, as shown in FIG. 1.

It could be though in connecting the twelve LEDs of each module 1 to a corresponding current regulator, but it will cause the disadvantage of having consumption dependences of the LEDs corresponding to the color components, that is, it would not be possible to separate the consumption of LEDs from a color component independently from the other two.

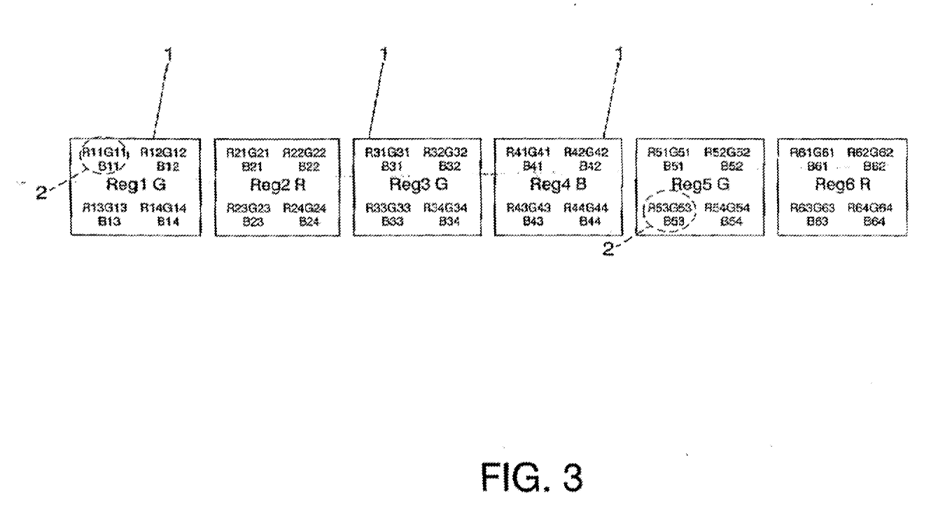

For this independence, the present example proposes a configuration as that represented in FIG. 3, wherein at each set of six modules 1 there are three regulators, Reg 1G, Reg 3G and Reg 5G generating constant currents to groups of eight green LEDs. In addition, there are two regulators, Reg 2R and Reg 6R generating constant currents to two groups of twelve red LEDs. Finally, a single regulator Reg 4B generates a constant current to a group of the twenty four blue LEDs of the set of six modules 1.

A simple way, among other many possibilities, for connecting the six regulators to the seventy two LED diodes at each set of six modules 1 is that showed in FIG. 3 and which is now described:

The regulator REG 1G is connected to green diodes G11, G12, G21, G22, G24, G23, G14 and G13.

The regulator REG 2R is connected to red diodes R22, R31, R32, R34, R33, R24, R23, R14, R13, R11, R12 and R21.

The regulator REG 3G is connected to green diodes G31, G32, G41, G42, G44, G43, G34 and G33.

The regulator REG 3B is connected to blue diodes B42, B51, B52, B61, B62, B64, B63, B54, B53, B44, B43, B34, B33, B24, B23, B14, B13, B11, B12, B21, B22, B31, B32 and B41.

The regulator REG 5G is connected to green diodes G51, G52, G61, G62, G64, G63, G54 and G53.

The regulator REG 6R is connected to red diodes R62, R64, R63, R54, R53, R44, R43, R41, R42, R51, R52 and R61.

Thus, the regulator REG 1G controls the green LEDs of the two left modules 1, the regulator REG 3G controls the green LEDs of the two central modules, while the regulator REG 5G controls the green LEDs of the two right modules. The regulator REG 2R controls the red LEDs of the three left modules, while the regulator REG 6R does the same with the red LEDs of the three right modules. Finally, the regulator REG 4B controls all the blue LEDs of the six modules 1; all of this as represented in FIG. 3.

This configuration allows that the sum of the direct tensions of all the LEDs connecting to the same regulator presents similar values in the six cases. For green LEDs, the maximum direct tension specified by the manufacturers is around four volts, which means that they have a total tension of 32 volts when are all turned on. The red LEDs presents a tension drop around 2.5 volts, resulting in a total tension drop of 30 volts under the same circumstances. On the other hand, the direct tension drop of blue LEDs is similar to that of the green LEDs, but generally the blue LEDs presents a luminosity excess of several times higher than that strictly necessary for a correct balance of white spots in the images represented in these video screens. This special characteristic can be used for dividing the total turn-on time of blue LEDs into three parts, so that in a certain moment of time no more than eight blue LEDs are simultaneously turned on. Thus, as happens with green LEDs, a sum of maximum tensions will be 32 volts for blue LEDs.

The flexible video screens implemented following this configuration must be made based on groups of six modules as those represented in FIG. 3.

Namely, with the presented solution, the consumption in each one of the three color components becomes independent and at the same time the tension drops of the seventy two LEDs that are in the six modules are efficiently divided between six regulators, all of this being easily integrated in a much reduced profile video screen.

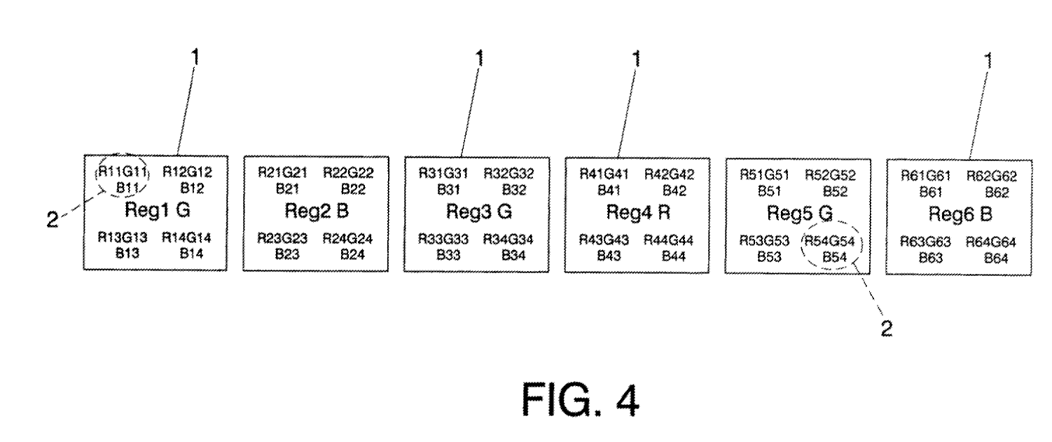

An alternative to the configuration of FIG. 3 has been represented in FIG. 4, wherein a single regulator for red LEDs and two regulators for blue LEDS are used. In this alternative is forecasted that only twelve out of the twenty four existing red LEDs are simultaneously turned on, whereas is also forecasted that only eight out of the twelve blue LEDs associated with the corresponding regulator are turned on. The convenience of the configuration of FIG. 3 or the one of FIG. 4 only depends on the characteristics of the used LEDs provided by the manufacturer.

1. CONFIGURATION OF CURRENT REGULATORS FOR LEDs-BASED FLEXIBLE VIDEO SCREENS wherein the video screen has a plurality of pixels (2) and each pixel is composed by a red LED (R), a green LED (G) and a blue LED (B); further existing current regulators (Reg) that provide constant currents to the respective groups of LEDs connected in series; and the pixels (2) being physically distributed in modules (1) with flexible joints between each other, presenting four pixels (2) each one of such modules (1); characterized in that such regulators (Reg) are applied to the corresponding groups of LEDs in function of the color of the LEDs and in numbers depending on the energetic requirements of the three types of LEDs; so that a first number of regulators wherein each regulator is only applied to red LEDs (R), a second number of regulators wherein each regulator is only applied to green LEDs (G) and a third number of regulators wherein each regulator is only applied to blue LEDs (B) will exist; thus allowing independence the consumption of the LEDs according to their color.

2. CONFIGURATION OF CURRENT REGULATORS FOR LEDs-BASED FLEXIBLE VIDEO SCREENS, according to claim 1, characterized in that such second number is established in an amount triple that of the referred third number, whereas the eluded first number is established in an amount double that of the referred third number.

3. CONFIGURATION OF CURRENT REGULATORS FOR LEDs-BASED FLEXIBLE VIDEO SCREENS, according to claim 2, characterized in that the screen is structured into lineal sets of modules (1), each lineal set being formed with six modules (1) provided with six respective regulators; so that a first regulator (Reg 1G) is applied to eight green LEDs of the two modules (1) arranged in the most left side of the lineal set, a third regulator (Reg 3G) is applied to eight green LEDs of the two central modules (1) of the lineal set, a fifth regulator (Reg 5G) is applied to eight green LEDs of the two modules (1) arranged in the most right side of the lineal set, a second regulator (Reg 2R) is applied to twelve red LEDs of the three modules (1) arranged in the most left side of the lineal set, a sixth regulator (Reg 6R) is applied to twelve red LEDs of the three modules (1) arranged in the most right side of the lineal set, and a fourth regulator (Reg 4b) is applied to twenty four blue LEDs of the six modules (1) of the lineal set.

4. CONFIGURATION OF CURRENT REGULATORS FOR LEDs-BASED FLEXIBLE VIDEO SCREENS, according to claim 3, characterized in that the total turn-on time of these twenty four blue LEDs is divided into three parts, so that in a certain moment of time no more than eight blue LEDs are simultaneously turned on.

5. CONFIGURATION OF CURRENT REGULATORS FOR LEDs-BASED FLEXIBLE VIDEO SCREENS, according to claim 1, characterized in that such second number is established in an amount triple that of the referred first number, whereas the eluded third number is established in an amount double that of the referred first number.

6. CONFIGURATION OF CURRENT REGULATORS FOR LEDs-BASED FLEXIBLE VIDEO SCREENS, according to claim 5, characterized in that the screen is structured into lineal sets of modules (1), each lineal set being formed with six modules (1) provided with six respective regulators; so that a first regulator (Reg 1G) is applied to eight green LEDs of the two modules (1) arranged in the most left side of the lineal set, a third regulator (Reg 3G) is applied to eight green LEDs of the two central modules of the referred set, a fifth regulator (Reg 5G) is applied to eight green LEDs of the two modules (1) arranged in the most right side of the lineal set, a second regulator (Reg 2B) is applied to twelve blue LEDs of the three modules (1) arranged in the most left side of the lineal set, a sixth regulator (Reg 6B) is applied to twelve blue LEDs of the three modules (1) arranged in the most right side of the lineal set, and a fourth regulator (Reg 4R) is applied to twenty four red LEDs of the six modules (1) of the lineal set.

7. CONFIGURATION OF CURRENT REGULATORS FOR LEDs-BASED FLEXIBLE VIDEO SCREENS, according to claim 6, characterized in that the total turn-on time of these twenty four red LEDs is divided into two parts, so that in a certain moment of time no more than twelve red LEDs are simultaneously turned on.

8. CONFIGURATION OF CURRENT REGULATORS FOR LEDs-BASED FLEXIBLE VIDEO SCREENS, according to claim 6, characterized in that the total turn-on time of these twelve blue LEDs is divided so that in a certain moment of time no more than eight blue LEDs are simultaneously turned on.
